(19) United States
(12) Patent Application Publication
(10) Pub. No.: US 2018/0101837 A1
(43) Pub. Date: Apr. 12, 2018

(54) NFC-Enabled Point of Sale System and Process

(71) Applicant: MASTERCARD INTERNATIONAL INCORPORATED, Purchase, NY (US)

(72) Inventors: Ajitesh Pandey, Pune (IN); Ravi Pareek, Pune (IN)

(21) Appl. No.: 15/725,920

(22) Filed: Oct. 5, 2017

(30) Foreign Application Priority Data
Oct. 6, 2016 (SG) 10201608410Y

(51) Int. Cl. G06Q 20/32; G06Q 20/20; H04B 5/00

(52) U.S. Cl. CPC G06Q 20/3278; H04B 5/0025; G06Q 20/204; G06Q 20/322

(57) ABSTRACT

There is provided a data processor implemented process for performing NFC enabled point-of-sale (POS) transactions on a computing device. Furthermore, there is also provided an NFC enabled point-of-sale (POS) transaction system.

### CROSS-REFERENCE TO RELATED APPLICATION

This application claims the benefit of and priority to Singapore Patent Application No. 10201608410Y filed Oct. 6, 2016. The entire disclosure of the above application is incorporated herein by reference.

### FIELD

The present disclosure relates to a near field communications (NFC)-enabled point of sale system and process for completing transactions between a customer and a merchant.

### BACKGROUND

This section provides background information related to the present disclosure which is not necessarily prior art.

The use of electronic payment services has increased dramatically in recent decades. In particular, credit and debit card-based payment services have become integrated into everyday life due to their ability to allow a customer to complete purchases via the electronic transfer of funds from a payment account to a merchant's account. Card-based payments offer many advantages over cash payments, including that the customer can transfer funds to a merchant in any currency without needing to transport physical denominations or having to manually perform conversions from one currency type to another, while retaining the efficiency of a cash exchange. More recently, mobile payment services (e.g., Paypal®, ApplePay®, Android Pay®, etc.) have been developed to allow customers to make payments without a physical credit or debit card, through the use of a portable mobile device, such as a smartphone. These services act as a “digital wallet” by storing the details of a customer's payment account and allowing the customer to make electronic payments from the account to a merchant without requiring the use of a physical card that is associated with the account.

Despite the convenience of these payment technologies, there remains room for improvement. It is desired to provide a system and process for NFC enabled POS transactions that alleviates one or more difficulties of the prior art, or to at least provide a useful alternative.

### SUMMARY

This section provides a general summary of the disclosure, and is not a comprehensive disclosure of its full scope or all of its features. Aspects and embodiments of the disclosure are set out in the accompanying claims.

There is provided a data processor implemented process for performing NFC enabled point-of-sale (POS) transactions on a computing device including: receiving merchant identification data representing the identity of a merchant; generating payment data representing a payment by a customer to the merchant, where the payment data indicates, at least, a payment account of the customer to be used for the payment, where said payment account is linked to a card association entity and to a corresponding issuing financial institution; generating financial transaction data based, at least in part, on the merchant identification data and the payment data, where the financial transaction data represents a POS transaction that would be generated by a merchant device of the merchant for said payment by the customer to the merchant; transmitting the generated financial transaction data directly to the card association entity for processing; and receiving financial transaction response data from the card association entity representing authorisation of the payment as determined by the issuing financial institution.

It is preferable that the merchant identification data is received by wireless communication between the computing device and the merchant device.

The wireless communication between the computing device and the merchant device is preferably performed using near field communication (NFC).

Preferably, the merchant identification information includes, for example, a merchant identifier, an acquirer ICA identifying the acquirer of the merchant, an indication of the default currency used by the merchant, and the like.

The NFC enabled point-of-sale transaction process can include receiving purchase information representing one of more of, for example, the payment amount; the payment currency; a brief narration of the goods or services to which the payment relates, and the like.

Preferably, the payment account of the customer is selected from, for example, a plurality of payment accounts of the customer, each payment account being linked to a card association entity, a corresponding issuing financial institution, and so forth.

It is preferable that one or more of the payment accounts of the customer are associated with a digital wallet accessible from the computing device, and where the payment account is selected by the digital wallet.

The generated financial transaction data preferably includes a standard ISO 8583 financial transaction.

It is preferable that the processing of the financial transaction data includes, for example, generating API selection data representing the selection of a function specified in a POS transaction application program interface (API) corresponding to the card association entity; transmitting the financial transaction data to the card association entity via the function selected from the POS transaction API, and so forth.

Preferably, the received financial transaction response data is processed to generate payment notification data, said payment notification data interpretable by the computing device to indicate the authorisation of the payment by the customer to a user of the computing device.

The payment notification data is preferably displayed visually by the computing device to indicate the authorisation of the payment by the customer to the user of the computing device.

The merchant device is preferably a POS device, and the financial transaction response data is transmitted to the merchant device to enable the settlement of the payment.

There is also provided an NFC enabled point-of-sale (POS) transaction system, including at least one computing device being configured to perform a POS transaction by carrying out the steps of: receiving merchant identification data representing the identity of a merchant; generating payment data representing a payment by the customer to the merchant, where the payment data indicates, at least, a payment account of the customer to be used for the payment, where said payment account is linked to the card association entity and to a corresponding issuing financial institution; generating financial transaction data based, at least in part, on the merchant identification data and the payment data, where the financial transaction data represents a POS transaction that would be generated by a merchant device of the merchant for said payment by the customer to the merchant; transmitting the generated financial transaction data directly to the card association entity for processing; and receiving financial transaction response data from the card association entity representing authorisation of the payment as determined by the issuing financial institution.

In another aspect, there is provided a process for processing a NFC enabled point-of-sale (POS) transaction executed on a server device, the process being executed by at least one processor, and including: receiving financial transaction data from a computing device via a function specified in a POS transaction application program interface (API) corresponding to a card association entity, said financial transaction data based, at least in part, on merchant identification data representing the identity of a merchant, and payment data representing a payment by a customer to the merchant, where the payment data indicates, at least, a payment account of the customer to be used for the payment, where said payment account is linked to the card association entity and to a corresponding issuing financial institution, and where the financial transaction data represents a POS transaction that would be generated by a merchant device of the merchant for said payment by the customer to the merchant; processing the received financial transaction data to generate payment request data representing a request for the payment; transmitting the payment request data to the issuing financial institution for authorisation of the payment; receiving request response data from the issuing financial institution representing an indication of whether the payment request is authorised or denied by said issuing financial institution; processing the request response data to generate financial transaction response data and acquirer notification data; and transmitting the financial transaction response data and the acquirer notification data to the computing device and the acquirer of the merchant respectively.

Preferably, the merchant identification information includes, for example, a merchant identifier, an acquirer ICA identifying the acquirer of the merchant, an indication of the default currency used by the merchant, and so forth.

The process can include receiving purchase information representing one of more of, for example, the payment amount; the payment currency; a brief narration of the goods or services to which the payment relates, and the like.

It is preferable that the generated financial transaction data includes a standard ISO 8583 financial transaction.

Further areas of applicability will become apparent from the description provided herein. The description and specific examples and embodiments in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure. Some embodiments of the present disclosure are hereinafter described, by way of example only, with reference to the accompanying drawings, wherein:

FIG. 1a is a block diagram of a NFC enabled point of sale system in accordance with some embodiments of the present disclosure;

FIG. 1b is a block diagram of a conventional point of sale system;

FIG. 2 is a block diagram of a computing device within the NFC enabled point of sale system;

FIG. 3 is a flow diagram of performing a NFC enabled point of sale transaction in accordance with some embodiments of the present disclosure;

FIG. 4 is a flow diagram of a process for obtaining merchant information of the NFC enabled point of sale transaction process;

FIG. 5 is a flow diagram of a POS payment request process of the NFC enabled point of sale transaction process;

FIG. 6 is a flow diagram of a process for processing a payment request of the NFC enabled point of sale transaction process;

FIG. 7 is a flow diagram of a process for displaying a response to a payment request of the NFC enabled point of sale transaction; and

FIG. 8 is a flow diagram of a process for notifying a merchant of the NFC enabled point of sale transaction process.

Corresponding reference numerals indicate corresponding parts throughout the several views of the drawings.

### DETAILED DESCRIPTION

Embodiments of the present disclosure, again, will be described, by way of example only, with reference to the drawings. The description and specific examples included herein are intended for purposes of illustration only and are not intended to limit the scope of the present disclosure.

The inventors have identified some specific shortcomings with existing mobile payment technologies. In particular, many forms of commercial activity, such as retail trade, card or mobile based electronic payments, are initiated at the merchant's point of sale (POS) device, such as an EFTPOS machine. POS devices often include a credit or debit card reader configured to obtain the details of a payment account associated with a customer's card, when the customer presents their card to the reader, and enables a payment to be made from that account subject, in some cases, to the customer authorising the payment (such as, for example, by entering a PIN code). Modern POS devices have evolved to use Near-Field Communication (NFC) technology to communicate with a customer's credit or debit card that contains a corresponding NFC tag, or with a mobile device which operates the customer's digital wallet.

The augmentation of existing payment solutions with NFC technology, as described above, has increased the ease and efficiency with which electronic payments may be made by a customer. However, existing NFC based payment solutions commonly rely on the merchant POS device for the purpose of initiating the payment transaction by capturing the customer's account information (either from a credit/debit card or a mobile device linked to the corresponding payment account of the card), and transmitting this information to an acquirer, such as a bank or financial institution, with whom the merchant has an associated account.

This reliance on the merchant POS device to conduct electronic payments has several drawbacks. First, the number of transactions that may be simultaneously performed is limited to the number of POS devices deployed by the merchant, since each device can only process a single transaction, for a single customer, at any one time. To minimise the risk of losing customers due to long payment queue times, merchants who experience a large difference between the number of payment transactions that are performed during “peak” and “off-peak” sales periods (such as retail outlets) will need to invest in an large number of POS devices in order to adequately service the high volume of transactions during the peak periods. However, this results in many POS devices being ‘idle’ during the off-peak periods, where these idle devices continue to consume resources (such as electrical power, storage space, etc.) while generating no benefit for the merchant.

Second, the ability to complete a payment is dependent on the ability of the POS device to maintain a connection to a local or wide area network in order to transmit transaction information to the acquirer. Most modern POS devices feature wireless connectivity to increase the convenience for customers making payments, such as, for example, wireless EFTPOS machines which may allow a customer at a restaurant to pay for their meal while still seated at their table. However, when connectivity between the POS device and the acquirer is lost, such as in the event of poor reception or the occurrence of a POS device fault, the merchant is left unable to accept electronic payments from the device. This can result in dissatisfaction for customers and a potential loss of revenue for the merchant.

Finally, there is a possibility that the security of a customer's payment account will be compromised whenever a merchant POS device is used by the customer to perform a payment. Merchant POS devices are often placed in locations that are exposed to public view, such as, for example, on the top of a checkout counter, and therefore require the customer to enter their PIN code, or other security credentials, in close proximity to, and/or within view of, other individuals. This can result in the security of the customer's associated payment account being compromised, and the customer subsequently sustaining economic loss and/or significant distress.

The described embodiments of the present disclosure include a NFC enabled point of sale (POS) system and process for completing an electronic payment transaction at a merchant site using a customer's mobile computer device. Specifically, in the described system and process a customer's mobile device, such as a smartphone or tablet, receives merchant identification information representing a merchant electronic payment credentials allowing the customer's device to act as a POS device for the merchant. Upon configuration as a POS device for the merchant, the customer's device is able to initiate a payment to the merchant without use of the merchant's own POS device. Payment to the merchant is made from a payment account of the customer that is linked to a particular card association entity (such as MasterCard® or Visa®). Transactions are generated by the customer device, when configured as a merchant POS device, in the form of standard financial transactions already used by financial institutions for the authorisation of payments against a customer's card-based payment account. The card association entity of the corresponding payment account receives transactions in the form of an ISO 8583—Financial transaction card originated messages—Interchange message specifications message as generated by the customer device through the use of one or more functions specified in the card association entity's corresponding application program interface (API).

The payment transactions produced by the system and process described herein are transmitted directly from the POS device (i.e., the customer device) to the card association entity. Following the receipt of the payment transaction, the card association entity processes the payment by obtaining authorisation from the customer's financial institution (referred to in the art as the “issuer”), and sends notification of the authorisation result back to the customer device, and also to the merchant's acquiring financial institution (referred to as the “acquirer”). Consequently, and in contrast to standard financial transaction processing methods, payment transactions generated by the customer device are not processed by the acquirer (or their corresponding payment processor) at any point prior to the authorisation of the payment by the issuer. The customer device transmits confirmation of the success or failure of the payment to the merchant POS device when the processing of the transaction is completed.

In the described embodiments of the system and process, communication between the customer device and the merchant POS device occurs via near field communication (NFC). Merchant identification information obtained by the customer device includes an identification number, an identifier for the merchant's acquirer, and an indication of the currency in which the merchant receives payments. Thus, the customer device uses the information received from the merchant to perform the POS functionality described herein by effectively assuming the identity of the merchant for the purpose of completing the payment. The customer device is able to utilise any communication method and/or protocol available to the device in its typical operation for the purpose of communicating with the card association entity. For example, a customer's smartphone device may transmit payment transaction information to the card association entity via a mobile telephone network (i.e., 3G or 4G), or over Wi-Fi.

A customer operates the customer device of the NFC enabled POS system and process through a POS software application executed on the device. In the described embodiments, the POS software application is a dedicated mobile application obtained by the customer (or user of the customer device) via a mobile application distribution store (such as Google® Play Store or Apple® Store). The POS software application can be configured to interact with one or more digital wallet applications that are pre-existing on the customer device. This enables the customer to initiate a payment to a merchant using the digital wallet, irrespective of whether direct support is provided by the merchant for payments from the customer's digital wallet.

The NFC enabled POS system described herein therefore advantageously provides a POS payment solution which:
1) allows customers to initiate payments to a merchant using their own mobile computing device, and as such eliminates bottlenecks which can result when the number of customers who wish to make a payment exceeds the number of merchant POS devices that are available;
2) improves the availability and reliability of electronic payment services by facilitating the use of mobile Internet or Wi-Fi connectivity to transmit payment transactions to the appropriate card association entity, since these connectivity services may be operational in situations where the merchant POS device cannot connect to the acquirer (and therefore cannot initiate a payment transaction via standard POS payment processes);
3) enables a customer to make payments with increased security, since PIN codes, or other security credentials, are entered into the customer's own device thus reducing the chance that a customer's payment account will be comprised; and
4) allowing a customer greater flexibility by enabling the use of their digital wallet to make payments to merchants in situations where the merchant's own POS devices do not support the digital wallet directly.

### System

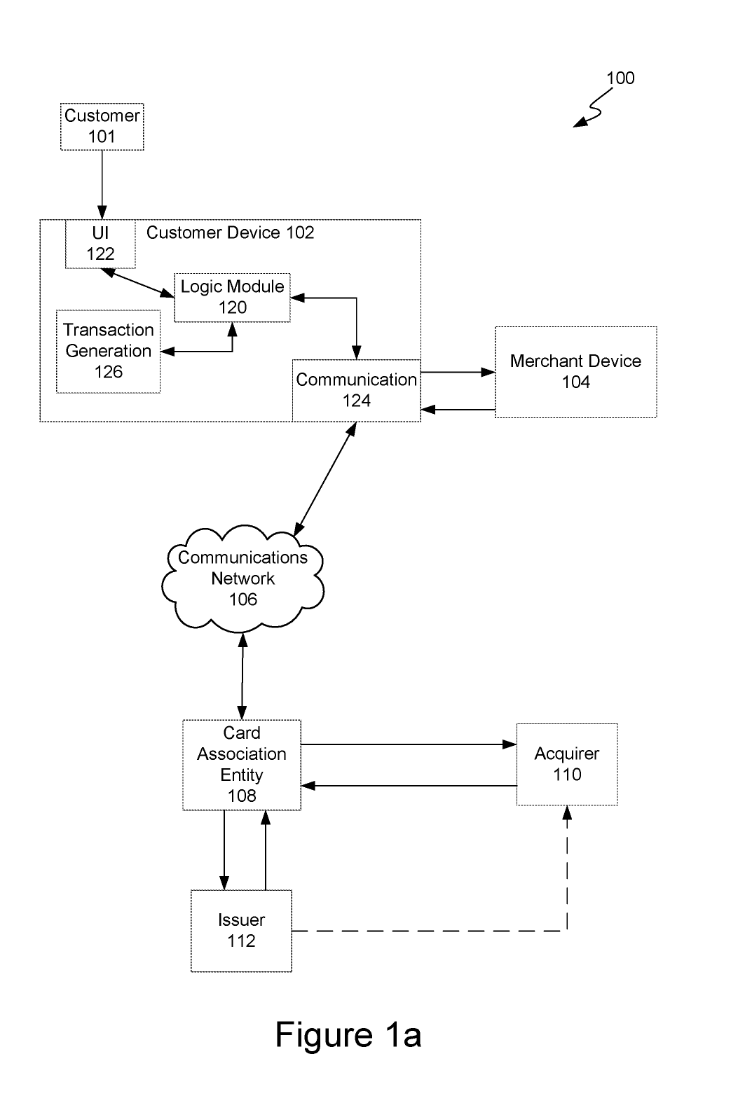

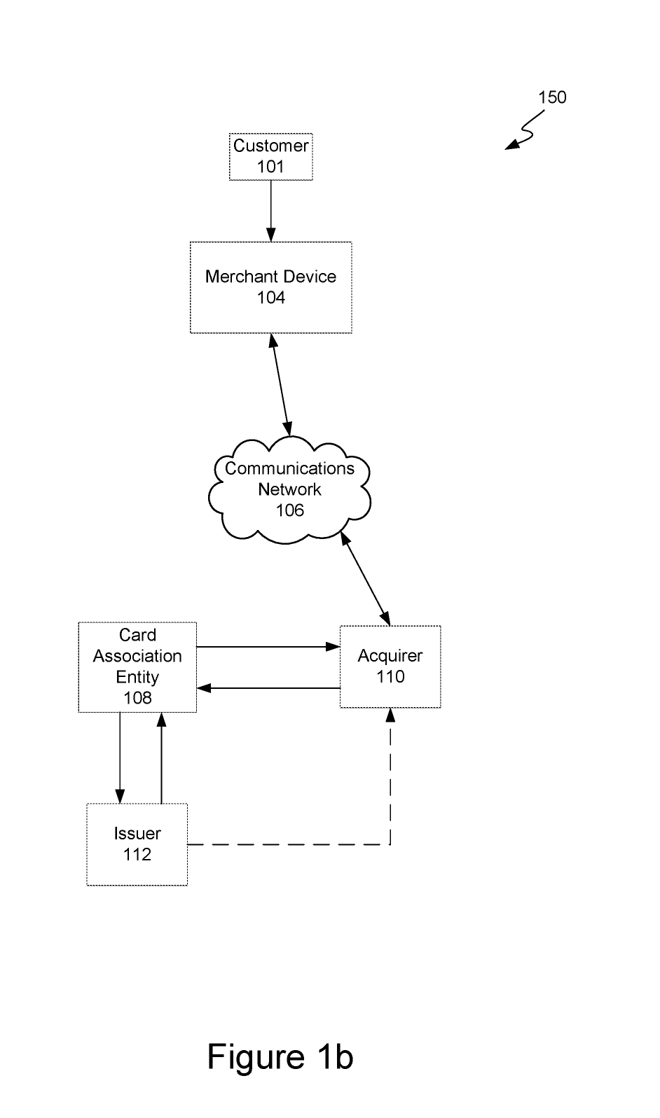

As shown in FIG. 1a, the NFC enabled POS system 100 includes a customer device 102 in local communication with a merchant device 104. A customer 101 operates the customer device 102 following a purchase order placed with the merchant in order to complete a payment for the purchase using the customer device 102 as the POS sale device. The card association entity 108 is a computing server device configured to receive financial transaction data from a customer device 102 of a customer having a financial payment account linked with the card association entity 108. Exchange of data between the customer device 102 and the card association entity 108 occurs over a communications network 106, which can be a local area network, or a wide area network, such as the Internet. In the described embodiments, a secure transport layer communications protocol, such as HTTPS, is used for the communication of data between the customer device 102 and card association entity 108.

The customer device 102 executes a POS application which enables the operation of the customer device 102 as a POS device for the particular merchant. The POS application of the described embodiments is a mobile application implemented in the form of software modules, including a user interface (UI) module 122, a logic module 120, a communication module 124 and a transaction generation module 126, as described below. POS payment requests are transmitted by the customer device 102 on behalf of the merchant and in association with the purchase order made by the customer 101, to the card association entity 108. The card association entity 108 communicates with the corresponding computing server devices of the issuer 112 to process the transaction, and to transmit corresponding notifications and/or responses to the merchant's acquirer 110. The processing of the payment transactions by the card association entity 108, and the communication occurring between the card association entity 108, the issuer 112, and the acquirer 110 is in accordance with standard financial payment system processes.

Significantly, in the NFC enabled POS system and process described herein, a payment request for the POS payment is transmitted from the customer device 102 directly to the card association entity 108. This differs from conventional systems for processing POS transactions, as shown in FIG. 1b, which rely on communication between the merchant device 104 and the acquirer 110 before the payment request reaches the card association entity 108. Specifically, in these conventional approaches, the merchant device 104 captures the customer's account information, generates the payment request transaction, and securely transmits the request to the acquirer 110. The acquirer 110 forwards the request transaction to the card association entity 108, which submits the transaction to the issuer 112 for authorisation. The response is then routed from the issuer 112 device back to the merchant device 104 to complete the transaction.

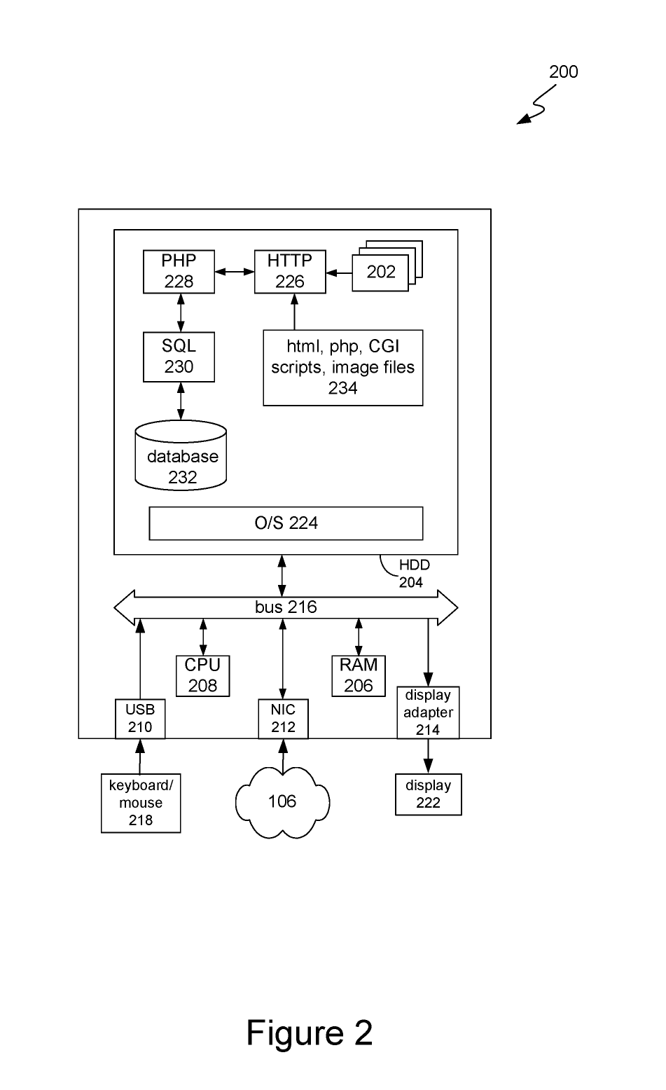

In the described embodiments of the NFC enabled POS system, the customer device 102, card association entity 108, acquirer 110, and issuer 112 devices are standard computer systems 200 such as, for example, an Intel IA-32 based computer system, as shown in FIG. 2, and the process 300 executed by the system 200 is implemented as programming instructions of one or more software modules 202 stored on non-volatile (e.g., hard disk or solid-state drive) storage 204 associated with the computer system, as shown in FIG. 2. However, it will be apparent that at least parts of the process 300 could alternatively be implemented as one or more dedicated hardware components, such as application-specific integrated circuits (ASICs) and/or field programmable gate arrays (FPGAs), for example.

The system 200 includes standard computer components, including random access memory (RAM) 206, at least one processor 208, and external interfaces 210, 212, 214, all interconnected by a bus 216. The external interfaces 210, 212, 214, include universal serial bus (USB) interfaces 210, at least one of which is connected to a keyboard 218 and a pointing device such as a mouse 218, a network interface connector (NIC) 212 which connects the system 200 to a communications network 106, such as the Internet, and a display adapter 214, which is connected to a display device such as an LCD or LED panel display 222.

The system 200 also includes a number of standard software modules 226 to 230, including an operating system 224 such as Linux® or Microsoft® Windows, web server software 226 such as Apache®, available at http://www.apache.org, scripting language module 228 such as PHP®, available at http://www.php.net, or Microsoft® ASP, and structured query language (SQL) module 230 such as MySQL®, available from http://www.mysql.com, which allows data to be stored in and retrieved from an SQL database 232.

Together, the web server 226, scripting language module 228, and SQL module 230 provide the system 200 with the general ability to allow users of the Internet 220 with standard computing devices equipped with standard web browser software to access the system 200 and, in particular, to provide data to and receive data from the database 232.

However, it will be understood by those skilled in the art that the specific functionality provided by the system 200 to such users is provided by scripts accessible by the web server 226, including the one or more software modules 202 implementing the process 300, and also any other supporting scripts and data 234, including markup language (e.g., HTML, XML) scripts, PHP (or ASP), and/or CGI scripts, image files, style sheets, and the like.

Accordingly, the customer can advantageously use their computing device (i.e. “customer device”), such as a mobile computer, tablet, or smartphone, to pay a merchant for a purchase order by executing the process for performing NFC enabled POS transactions described herein, which involves:
receiving merchant identification data representing the identity of a merchant;
generating payment data representing a payment by the customer 101 to the merchant, where the payment data indicates, at least, a payment account of the customer 101 to be used for the payment, where the payment account is linked to the card association entity 108 and to a corresponding issuing financial institution (i.e. the issuer 112);
generating financial transaction data based, at least in part, on the merchant identification data and the payment data, where the financial transaction data represents a point of sale (POS) transaction that would be generated by the merchant device 104 for the payment by the customer 101 to the merchant;
transmitting the generated financial transaction data directly to the card association entity 108 for processing; and
receiving financial transaction response data from the card association entity 108 representing the authorisation or denial of the payment, said authorisation or denial of the payment determined by the issuer 112.

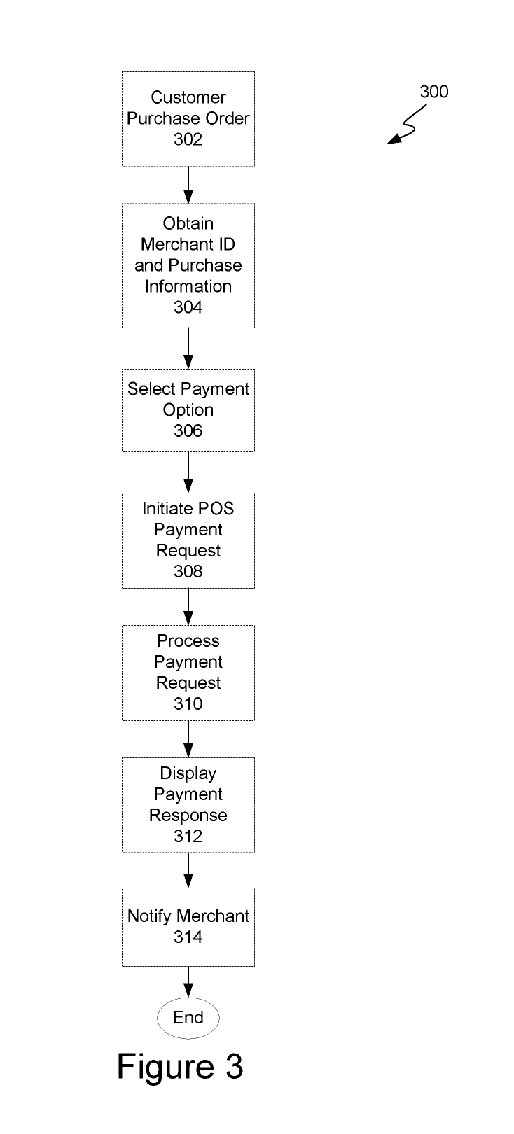

FIG. 3 illustrates the process of performing a NFC enabled POS payment with the system 100. A customer 101 first places a purchase order with the merchant at step 302. Following the placement of the purchase order, a customer 101 wishing to make a payment for the purchase interacts with the POS application executing on the customer device 102 via graphical user interface (GUI) display elements rendered on the customer device 102 by the UI module 122. The UI module 122 presents options to the customer 101 including an option to commence NFC enabled POS functionality. The customer 101 selects this option to commence operation of the customer device 102 as a POS payment device for a particular merchant.

The customer device 102 is configured as a POS device for a merchant by obtaining merchant ID information and purchase order information at step 304. Merchant ID information is received by the customer device 102 via wireless communication with the merchant device 104. In described embodiments, this communication uses the NFC protocol which allows the transfer of data between the customer device 102 and the merchant device 104 when these devices are placed in close physical proximity. The modulation scheme, coding, transfer speed and frame format used during NFC communication between the customer 101 and merchant devices 104 are set according to NFC air interface standards ECMA-340 and ISO/IEC 18092.

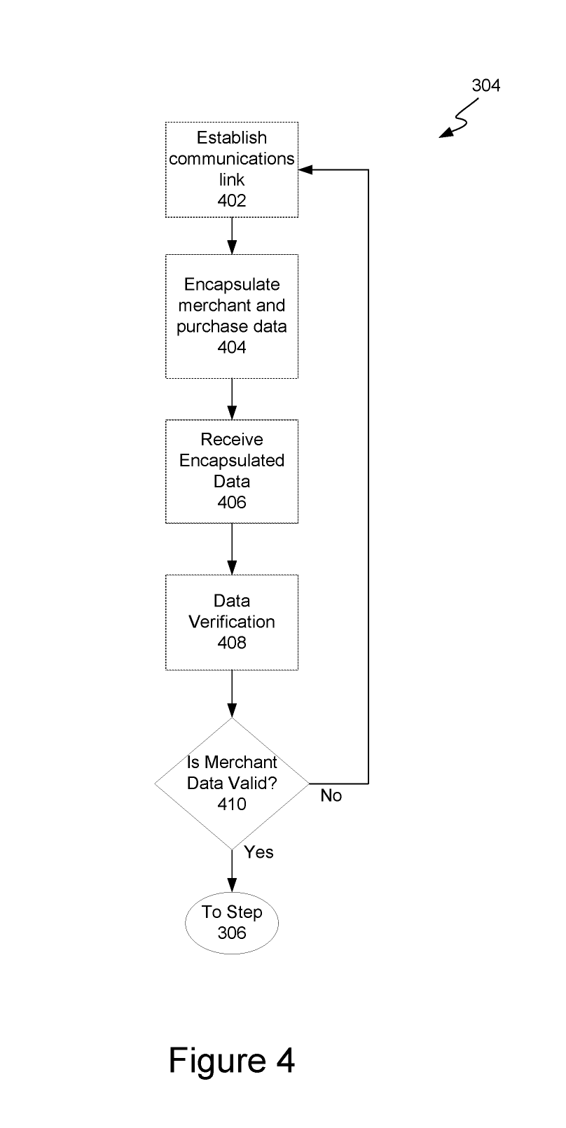

FIG. 4 illustrates the process of obtaining merchant ID information and payment information from merchant device 104. The process is initiated when the customer 101 selects an option on the GUI of the POS application indicating that the customer device 102 is ready to commence the information transfer. At step 402, a NFC link is established between the customer device 102, acting as the passive device, and the NFC enabled merchant device 104, acting as the initiator. The merchant ID information obtained by the customer device 102 from the merchant device 104 includes: a merchant identifier, an acquirer ICA identifying the acquirer of the merchant, and an indication of the default currency used by the merchant. In the described embodiments, the customer device 102 also receives purchase information representing the purchase order made by the customer 101 from the merchant. Purchase information includes the payment amount, the payment currency, and a brief narration of the goods or services to which the payment relates. In other embodiments, the transfer of information from the merchant device 104 to the customer device 102, at step 304, may be limited to the merchant ID information. In such embodiments, the POS application can accept purchase information as input entered into the GUI elements by the user of the customer device 102, either prior to, or after, the merchant ID information is obtained.

The merchant ID and purchase information is encapsulated by the merchant device 104 prior to transmission to the customer device 102, at step 404. Encryption is applied to the merchant ID and purchase information using a symmetric key algorithm (such as AES). The encryption is performed using a cryptographic key that is stored in the logic module 120 of the POS application and within the corresponding software module of the merchant device 104. In alternative embodiments of the system 100, the encryption key is dynamically generated by the logic module 120, and is transmitted (via a standard key exchange protocol such as, for example, Diffie-Hellman) from the customer device 102 to the merchant device 104 prior to the encapsulation process of step 404.

At step 406, the merchant device 104 transmits the encapsulated data containing the merchant ID and purchase information to the customer device 102. The communications module 124 receives merchant ID and payment information data from the merchant device 104, and transfers the data to the logic module 120 for processing. The logic module 120 extracts the merchant ID and purchase information and performs validity checking, at step 408, to ensure that the merchant ID and purchase information data has not been corrupted during transmission. Validity checking involves the calculation of checksum values, produced according to a checksum algorithm (such as md5sum or sha1sum), over the values of the merchant ID and purchase information data fields. That is, at step 410, the validity checking involves a comparison between the checksum values calculated by the merchant device 104 and encapsulated in the transmitted data, and the values calculated by the customer device 102 over the same respective merchant ID and purchase information data fields. If the checksum values differ, then the logic module 120 reports a transmission error to the UI module 122, which may subsequently report the error to the user of the customer device 102 through the GUI elements. In this case, on confirmation by the user of the customer device 102, the POS application attempts to repeat the data transfer, encapsulation and verification steps, as previously described.

In the embodiments of the system and process described herein, the merchant device 104 is an NFC enabled device, such as an EFTPOS machine. However, in some cases, an NFC enabled device may not be available for communication with the customer device 102. This includes situations where all of the merchant's devices are in use, where none of the NFC capable merchant devices 104 can be placed in close enough proximity to the customer 101, and where the merchant does not use POS devices with NFC capability. In these circumstances, the NFC enabled POS process can obtain merchant ID information from an NFC chip residing within a card, or another inactive device, held by the merchant. The customer device 102 can operate in “active” NFC mode to read the NFC chip, or inactive device, and subsequently receive the merchant ID information. Verification of the received merchant ID information is then performed in accordance with steps 408 and 410, as described above.

Once the merchant ID and purchase information has been received and verified by the customer device 102, at step 306, the POS application allows the selection of a payment option for the POS transaction. The UI module 122 displays on the GUI of the customer device 102 a list of payment accounts of the customer 101 which are eligible for use to perform the POS transaction (such as a credit or debit card based account). In some embodiments, the POS application is configured to recognise the presence of the digital wallet application on the customer device 102. The UI module 122 presents display elements allowing the customer 101 to pay via their digital wallet as an alternative to selecting a pre-entered payment account from the displayed list. This allows the customer 101 to make payments to merchants using their digital wallet, even in circumstances where these types of digital wallet payments are not explicitly supported by the corresponding merchant devices 104. In some embodiments, the selection of a payment account (i.e., step 306) is omitted from the payment process 300, such as when the customer 101 elects to perform the transaction in an “express checkout” mode, or similar. In these embodiments, the POS application is configured to use a default payment account of the customer 101 to perform the payment.

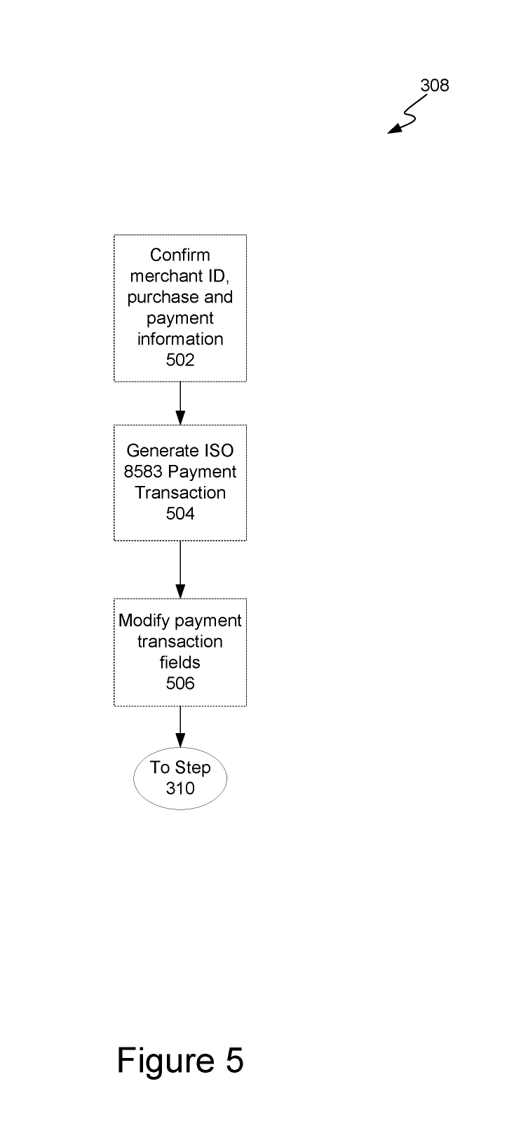

At step 308, the customer device 102 initiates the POS payment request based on the merchant ID, purchase and payment information obtained in steps 304 and 306, as described above. As shown in FIG. 5, the merchant ID information, purchase information and payment information is first displayed, at step 502, on the GUI of the customer device 102. The UI module 122 presents a confirmation element onto the customer device 102 GUI allowing the customer 101 to verify that the merchant and purchase details are correct, and to confirm that a payment of the specified amount and currency is to be made from the selected payment account (or digital wallet). If the payment is confirmed, then at step 504 data representing a financial transaction is generated by the payment transaction generation module 126.

At step 506, the payment transaction generation module 126 generates the values for the data fields of the ISO 8583 transaction. Table 1 illustrates the ISO 8583 data field values which are set by the POS application during the generation of the payment request by the customer device 102. Specifically, data field 2 reflects the customer's selected (or default) payment account. Data fields 4-10 are set to represent the amount and currency of the payment, any associated conversion fees that are required, and the timing information of the transaction. The merchant ID information is used to set the data field values 18-21, representing the merchant type, the acquiring institution country code, the PAN value, and the forwarding institution country code respectively.

TABLE 1

| ISO 8583 | | |
|---|---|---|
| Data Field | Type | Description |
| 2 | n . . . 19 | Primary account number (PAN) |
| 4 | n 12 | Amount, transaction |

. . .

| | | |
|---|---|---|
| 5 | n 12 | Amount, settlement |
| 6 | n 12 | Amount, cardholder billing |
| 7 | n 10 | Transmission time |
| 8 | n 8 | Amount, cardholder billing fee |
| 9 | n 8 | Conversion rate, settlement |
| 10 | n 8 | Conversion rate, cardholder billing |

. . .

| | | |
|---|---|---|
| 18 | n 4 | Merchant type |
| 19 | n 3 | Acquiring institution country code |
| 20 | n 3 | PAN extended country code |
| 21 | n 3 | Forwarding institution country code |

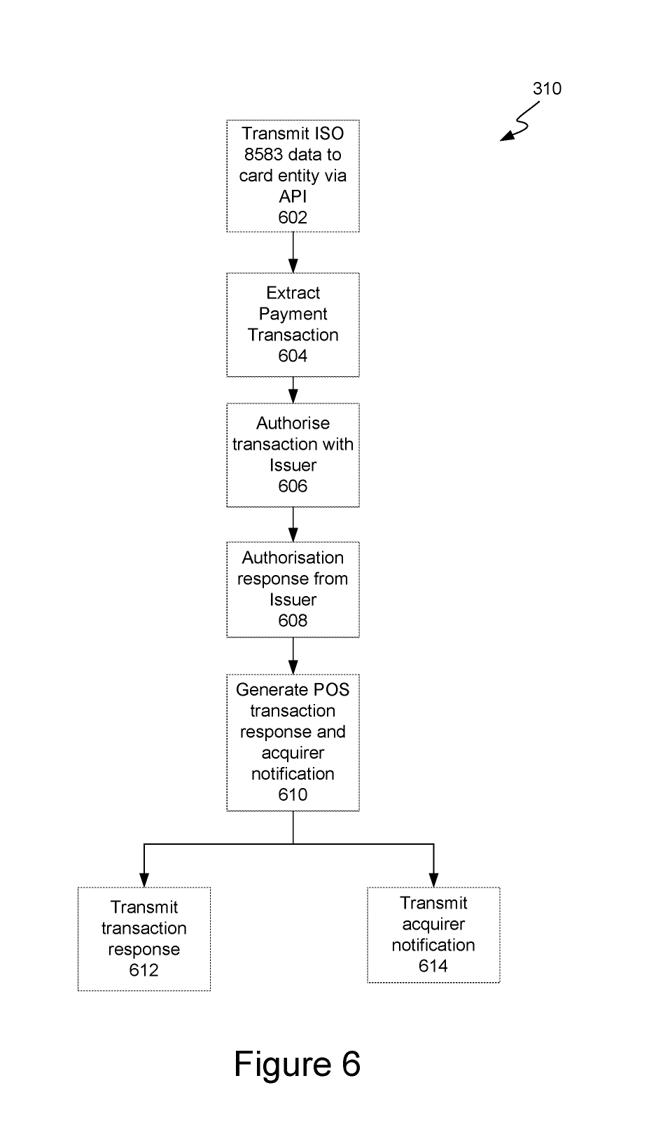

The generated payment transaction is processed, at step 310, according to the procedure shown in FIG. 6. At step 602, the payment transaction is transmitted to the card association entity 108 via a call to a predefined function specified by an application program interface (API) of the card association entity 108. When the generation of the payment transaction is complete, the payment transaction generation module 126 sends the payment transaction data to the logic module 120 to prepare the payment transaction for transmission to the card association entity 108. As communication between the customer device 102 and the card association entity 108 can be performed over a potentially untrusted communications network 106 (such as the Internet or a mobile network), secure data transfer protocols are used to transmit the payment transaction information. In some embodiments, security is provided at the application layer level by the encryption of the payment transaction, specifically encryption of the PIN, where the encryption key is known by both the card association entity 108 and the POS application of the customer device 102.

The logic module 120 prepares the payment transaction data for transmission, including performing the encryption or securitisation of the transaction, as described above, and subsequently invokes the communications network 106 to perform the data transfer. The data transfer is initiated by one or more calls to the functions defined by a point-of-sale (POS) API. The POS application includes an API library containing one or more POS APIs, where each API is associated with a particular card association entity organisation (e.g., MasterCard®, Visa®, etc.). Each of the POS APIs specifies a set of functions that allow a customer device 102 to securely transmit a payment transaction to the particular corresponding card association entity. The API library data is maintained by the logic module 120 of the POS application executing on the customer device 102. The logic module 120 determines the appropriate API to use for transmission of the payment transaction based on the payment account with which the transaction is to be performed, and the card association entity that is linked to this particular account. For example, a payment transaction generated for a customer's ‘ANZ MasterCard® Platinum Credit Card’ account will result in the logic module 120 selecting the MasterCard® POS API from the API library.

The function specified by a particular card association entity POS API enables the payment transaction to be sent from the customer device 102 to the corresponding card association entity 108 under a variety of different conditions and/or transfer modes. For example, an API can include a subset of functions allowing the processing of transaction data that is provided in one of various different formats, such as a byte array or string. Other functions may specify the data transfer mode of the payment transaction transmission (such as synchronous or asynchronous modes), and/or the particular type of acknowledgement or return value that is to be provided to the customer device 102 by the card association entity 108 in response to receiving the payment transaction data. The specific API function used to transmit the payment transaction data is determined by the logic module 120 based on the configuration of the POS application and the operating system of the customer device 102.

Following the successful transmission of the payment transaction data from the customer device 102 to the card association entity 108, at step 604 the card association entity 108 extracts the payment transaction information from the received data. The extraction process is specific to the type and format of the data received. Decryption is applied to the received data in accordance with the encryption and/or security measures applied to the payment transaction fields by the POS application prior to transmission, as described above. Once extraction of the payment data is complete, the card association entity 108 parses the payment transaction data to determine the corresponding issuer 112 of the customer's payment account. Communication between the card association entity 108 and the issuer 112 occurs over an internal secure network established between the respective institutions, in accordance with financial transaction processing standards.

At step 606, the card association entity 108 transmits the payment transaction to the issuer 112 to obtain authorisation for the payment. The payment transaction is received by the issuer 112 and a response is transmitted back to the card association entity 108 indicating the authorisation or denial of the payment. The authorisation or denial of the payment by the issuer 112 is determined based on the specific details of the customer's payment account and, in some circumstances, the details of the merchant and/or their acquirer 110, in accordance with standard procedures for processing financial transactions. The card association entity 108 receives an authorisation response from the issuer 112, at step 608, and generates payment transaction response data and acquirer notification data for the customer device 102 and the acquirer 110 respectively, at step 610. In the case where the payment is authorised by the issuer 112, the payment transaction response data is transmitted to the customer device 102, at step 612. Corresponding acquirer notification data is transmitted to the acquirer 110 at step 614, and is subsequently processed to enable the clearing of funds for deposit into the merchant's corresponding account. Therefore, the execution of steps 602 to 614 results in a secure exchange of the POS payment transaction and the associated response between the customer device 102, acting as a merchant POS device, and the devices of the card association entity 108 linked to the customer's corresponding payment account.

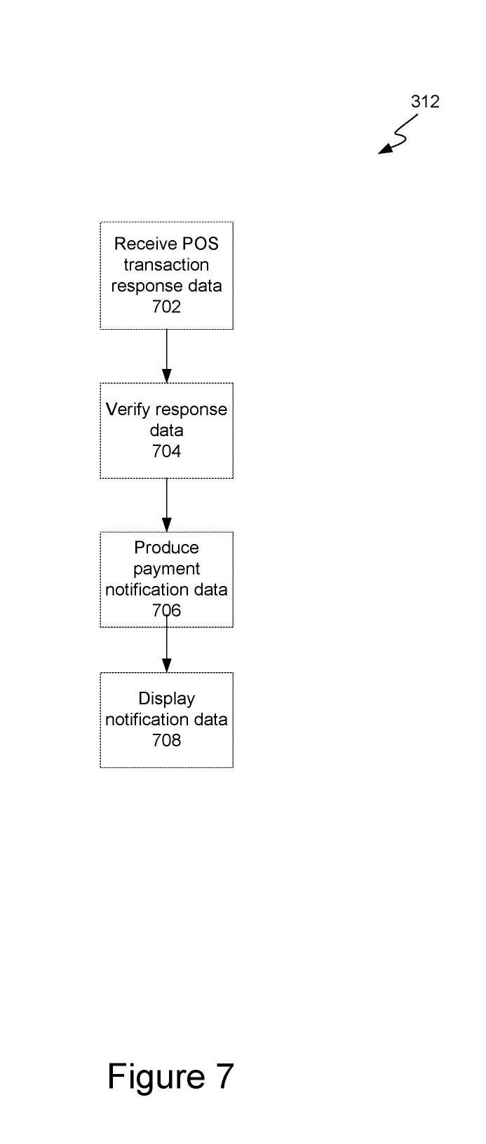

The POS application displays a notification of the completion of the POS payment at step 312 of the NFC enabled POS payment process 300. As shown in FIG. 7, at step 702, the payment transaction response data is received by the communications network 106 of the POS application executing on the customer device 102. The received payment transaction response data is decrypted and verified (as described above) at step 704 to ensure that the response is not affected by error corruption, or by any unauthorised modification, during transmission through the communications network 106.

At step 706, the response data is processed to produce notification data, which indicates the success or failure of their POS payment to the customer 101. The notification data includes an authorisation response representation (such as, for example, a string in the form of “authorised” or “denied”) indicating whether or not the payment has been approved by the issuer 112. In some embodiments, the notification data also includes a summary of the purchase order, merchant ID and payment account information. The logic module 120 transmits the generated notification data to the UI module 122, which displays the notification data graphically on one or more elements of the GUI of the customer device 102 (at step 708). The UI module 122 is configured to provide GUI elements that allow the customer 101 to capture the payment notification information in the form of an invoice or receipt. The customer 101 can elect to save a copy of the receipt to the local storage of the customer device 102 using a standard file storage format (such as PDF), and/or to print the invoice or receipt to a connected output device.

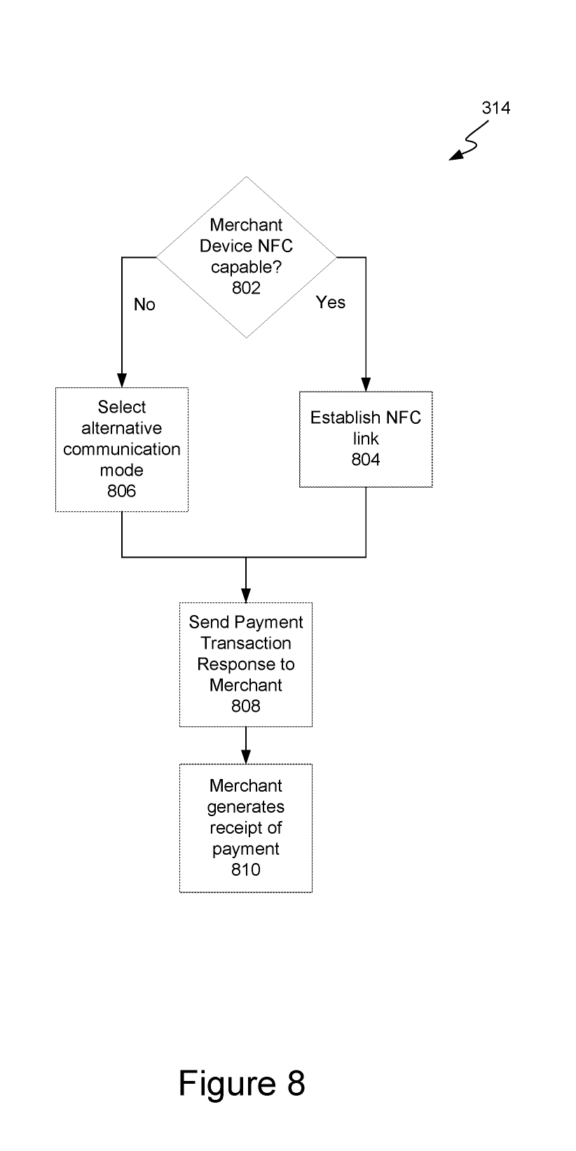

At step 314 of the NFC enabled POS payment process 300, the POS application is configured to notify the merchant of the payment request response by communication between the customer device 102 and the merchant device 104. As shown in FIG. 8, at step 802, the payment transaction response data is transmitted to the merchant device 104 where the transmission is based on the NFC communication capability of the merchant device 104. If the merchant device 104 is capable of NFC communication (such as an NFC enabled EFTPOS transaction machine), then, at step 804, transmission of the payment transaction response is performed via NFC, in accordance with the processes described above.

Otherwise, if the merchant device 104 is not an NFC enabled device then, at step 806, the POS application allows the customer 101 to select an alternative connectivity option (such as, for example, a USB connection) through which payment transaction response data is sent to the merchant device 104 (i.e., at step 808). The merchant device 104 processes the payment transaction response data received from the customer device 102 and provides a notification of the success or failure of the POS payment to the merchant. For example, if the merchant device 104 is an EFTPOS device a “Transaction Approved” or “Transaction Declined” message may be indicated visually on the screen or display of the device to reflect the success or failure of the payment respectively. At step 810, the merchant can choose to print a receipt of the transaction from the merchant device 104 using a similar process to that available during a traditional POS payment conducted via the merchant device 104 (i.e., as shown in FIG. 1b). The details of the transaction are transmitted from the merchant device 104 to the acquirer 112 to allow for the settlement of the payment, in accordance with standard processes for completing a financial transaction.

Many modifications will be apparent to those skilled in the art without departing from the scope of the present disclosure.

Throughout this specification, unless the context requires otherwise, the word “comprise”, and variations such as “comprises” and “comprising”, will be understood to imply the inclusion of a stated integer or step or group of integers or steps but not the exclusion of any other integer or step or group of integers or steps.

With that said, and as described, it should be appreciated that one or more aspects of the present disclosure transform a general-purpose computing device into a special-purpose computing device (or computer) when configured to perform the functions, methods, and/or processes described herein. In connection therewith, in various embodiments, computer-executable instructions (or code) may be stored in memory of such computing device for execution by a processor to cause the processor to perform one or more of the functions, methods, and/or processes described herein, such that the memory is a physical, tangible, and non-transitory computer readable storage media. Such instructions often improve the efficiencies and/or performance of the processor that is performing one or more of the various operations herein. It should be appreciated that the memory may include a variety of different memories, each implemented in one or more of the operations or processes described herein. What's more, a computing device as used herein may include a single computing device or multiple computing devices.

In addition, the terminology used herein is for the purpose of describing particular exemplary embodiments only and is not intended to be limiting. As used herein, the singular forms “a,” “an,” and “the” may be intended to include the plural forms as well, unless the context clearly indicates otherwise. And again, the terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A data processor implemented process for performing NFC enabled point-of-sale (POS) transactions on a computing device, the process comprising:
receiving merchant identification data representing the identity of a merchant;
generating payment data representing a payment by a customer to the merchant, where the payment data indicates, at least, a payment account of the customer to be used for the payment, where said payment account is linked to a card association entity and to a corresponding issuing financial institution;
generating financial transaction data based, at least in part, on the merchant identification data and the payment data, where the financial transaction data represents a POS transaction that would be generated by a merchant device of the merchant for said payment by the customer to the merchant;
transmitting the generated financial transaction data directly to the card association entity for processing; and
receiving financial transaction response data from the card association entity representing authorization of the payment as determined by the issuing financial institution.

2. The NFC enabled point-of-sale transaction process of claim 1, wherein the merchant identification data is received by wireless communication between the computing device and the merchant device.

3. The NFC enabled point-of-sale transaction process of claim 2, wherein the wireless communication between the computing device and the merchant device is performed using near field communication (NFC).

4. The NFC enabled point-of-sale transaction process of claim 1, wherein the merchant identification information includes: a merchant identifier, an acquirer ICA identifying the acquirer of the merchant, and an indication of the default currency used by the merchant.

5. The NFC enabled point-of-sale transaction process of claim 1, further comprising including receiving purchase information representing one of more of: the payment amount, the payment currency, and a brief narration of the goods or services to which the payment relates.

6. The NFC enabled point-of-sale transaction process of claim 1, wherein the payment account of the customer is selected from a plurality of payment accounts of the customer, each payment account being linked to a card association entity and a corresponding issuing financial institution.

7. The NFC enabled point-of-sale transaction process of claim 6, wherein one or more of the payment accounts of the customer are associated with a digital wallet accessible from the computing device, and where the payment account is selected by the digital wallet.

8. The NFC enabled point-of-sale transaction process of claim 1, wherein the generated financial transaction data includes a standard ISO 8583 financial transaction.

9. The NFC enabled point-of-sale transaction process of claim 1, further comprising processing the financial transaction data; and
wherein processing the financial transaction data includes:
generating API selection data representing the selection of a function specified in a POS transaction application program interface (API) corresponding to the card association entity; and
transmitting the financial transaction data to the card association entity via the function selected from the POS transaction API.

10. The NFC enabled point-of-sale transaction process of claim 1, further comprising processing the received financial transaction response data to generate payment notification data, said payment notification data interpretable by the computing device to indicate the authorization of the payment by the customer to a user of the computing device.

11. The NFC enabled point-of-sale transaction process of claim 10, further comprising displaying wherein the payment notification data visually, by the computing device, to indicate the authorization of the payment by the customer to the user of the computing device.

12. The NFC enabled point-of-sale transaction process of claim 1, wherein the merchant device is a POS device, and further comprising transmitting the financial transaction response data to the merchant device to enable the settlement of the payment.

13. An NFC enabled point-of-sale (POS) transaction system comprising at least one computing device configured, connection with performing a POS transaction, by:
receive merchant identification data representing the identity of a merchant;
generate payment data representing a payment by the customer to the merchant, where the payment data indicates, at least, a payment account of the customer to be used for the payment, where said payment account is linked to the card association entity and to a corresponding issuing financial institution;
generate financial transaction data based, at least in part, on the merchant identification data and the payment data, where the financial transaction data represents a POS transaction that would be generated by a merchant device of the merchant for said payment by the customer to the merchant;
transmit the generated financial transaction data directly to the card association entity for processing; and
receive financial transaction response data from the card association entity representing authorisation of the payment as determined by the issuing financial institution.

14. The NFC enabled point-of-sale (POS) transaction system of claim 13, wherein the merchant identification data is received by wireless communication between the at last one computing device and the merchant device.

15. A process for processing an NFC enabled point-of-sale (POS) transaction executed on a server device, the process comprising:
receiving, by at least one processor, financial transaction data from a computing device via a function specified in a POS transaction application program interface (API) corresponding to a card association entity, said financial transaction data based, at least in part, on merchant identification data representing the identity of a merchant, and payment data representing a payment by a customer to the merchant, where the payment data indicates, at least, a payment account of the customer to be used for the payment, where said payment account is linked to the card association entity and to a corresponding issuing financial institution, and wherein the financial transaction data represents a POS transaction that would be generated by a merchant device of the merchant for said payment by the customer to the merchant;
processing the received financial transaction data to generate payment request data representing a request for the payment;
transmitting the payment request data to the issuing financial institution for authorisation of the payment;
receiving request response data from the issuing financial institution representing an indication of whether the payment request is authorized or denied by said issuing financial institution;
processing the request response data to generate financial transaction response data and acquirer notification data; and
transmitting the financial transaction response data and the acquirer notification data to the computing device and the acquirer of the merchant respectively.

16. The process of claim 15, wherein the merchant identification information includes: a merchant identifier, an acquirer ICA identifying the acquirer of the merchant, and an indication of the default currency used by the merchant.

17. The process of claim 15, further comprising receiving purchase information representing one of more of: the payment amount, the payment currency, and a brief narration of the goods or services to which the payment relates.

18. The process of claim 15, wherein the generated financial transaction data includes a standard ISO 8583 financial transaction.
